(19) United States
(12) Patent Application Publication
(10) Pub. No.: US 2025/0047972 A1
(43) Pub. Date: Feb. 6, 2025

(54) HAPTIC FEEDBACK CONTROL FOR TRACKING AN IMAGE OF AN OBJECT

(71) Applicant: ENDLESS TECHNOLOGIES LTD., Ramat-Gan (IL)

(72) Inventors: Liron HERTZ, Givataim (IL); Nimrod SANDLERMAN, Ramt-Gan (IL)

(21) Appl. No.: 18/365,661

(22) Filed: Aug. 4, 2023

Related U.S. Application Data
(60) Provisional application No. 63/397,391, filed on Aug. 12, 2022.

(51) Int. Cl. H04N 23/60; G06T 7/20; H04N 23/62

(52) U.S. Cl. CPC H04N 23/64; G06T 7/20; H04N 23/62; G06T 2207/20081

(57) ABSTRACT

A wearable imaging device enables a user to orient a camera at a region of interest, capture an image of the region of interest, and track the region of interest, without looking at a display screen by capturing a plurality of frames, each comprising an image of a scenery comprising the object, detecting a motion of the object within the scenery, and providing a haptic signal to the user, the haptic signal informing the user how to move the wearable imaging device to keep the object within the captured scenery.

### FIELD

The method and apparatus disclosed herein are related to the fields of imaging and hand-held devices, and more particularly but not exclusively, to wearable computing devices, and more particularly but not exclusively, to wearable imaging devices.

### BACKGROUND

Imaging devices such as miniature digital cameras are being embedded in various portable, handheld, and wearable devices. Many personal portable devices such as smartphones may include more than one camera, as well as two or more cameras oriented at different angles, for example, a forward looking (landscape) camera and a backward looking (selfie) camera. All such imaging devices may have a display screen for displaying the captured image. The display enables the user to orient the camera at a selected object and follow the object as the object moves, or as the user moves with the camera with respect to the tracked abject. In most situations the object of interest is a small part of the image captured, and the image captured is a small portion of the entire scenery.

However, there are situations in which the user may prefer to look at the object directly (not via the display) or at other parts of the scenery, while the imaging device tracks the desired object or piece of the scenery. Automatic tracking of the object of interest may be achieved with a motorized imaging device. However wearable imaging devices are intended for manual operation and thus lack motor manipulation.

### SUMMARY OF THE INVENTION

According to one exemplary embodiment, there is provided a device, a method, and a software program enabling a user to orient a camera at a region of interest, capture an image of the region of interest, and track the region of interest, without looking at a display screen.

According to another exemplary embodiment, the device, method, and/or software program instructs the user of the wearable imaging device to point the wearable imaging device in a direction of a selected object by capturing a plurality of frames, each comprising an image of a scenery comprising the object, detecting a motion of the object within the scenery, and providing a haptic signal to the user, the haptic signal informing the user how to move the wearable imaging device to keep the object within the captured scenery.

According to yet another exemplary embodiment, the device, method, and/or software program additionally includes detecting at least one of: the direction of motion of the object within the frame, the speed of motion of the object within the frame, and the distance of the object from an edge of the frame.

According to still another exemplary embodiment, the device, method, and/or software program the haptic signal to the user comprises at least one of: a measure of the direction of motion of the object within the frame, a measure of the speed of motion of the object within the frame, and a measure of the distance of the object from the edge of the frame.

Further according to another exemplary embodiment, the device, method, and/or software program additionally includes detecting the object within the scenery the detecting including at least one of: collecting a plurality of images of the object from different angles, producing a 3D model of the object based on the collected plurality of images of the object, using the 3D model, rendering a plurality of images of the object from intermediate angles to create a training collection of images, using the training collection of images, training an imaging AI-model for recognizing the object, and using the imaging AI-model to detect the object in the captured scenery.

Yet further according to another exemplary embodiment, the device, method, and/or software program additionally includes receiving from the imaging AI-model a measure of validity of the detection of the object in the scenery, instructing at least one of: instructing the rendering of at least one image of the object from intermediate angles to add to the training collection of images, and instructing the training of a new imaging AI-model for recognizing the object.

Still further according to another exemplary embodiment, the device, method, and/or software program additionally includes detecting a motion of the wearable imaging device responsive to the haptic signal provided to the user, creating a training collection of responses comprising a plurality of motions of the wearable imaging device responsive to a respective haptic signals provided to the user, using the training collection of responses, training a signaling AI-model, using the signaling AI-model, producing the haptic signal provided to the user.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1A is a simplified illustration of a side view of a wearable imaging device;

FIG. 1B is a simplified illustration of a top view of the wearable imaging device;

FIG. 2 is a simplified block diagram of a computational device with the imaging devices;

FIG. 3 is a simplified illustration of a wearable complex including a wearable article and two computational devices;

FIG. 4 is a simplified block diagram of wearable complex including a block diagram of a computational device and a block diagram of an imaging device;

FIG. 5A is a simplified illustration of an imaging device from the inward (wrist) side;

FIG. 5B is a simplified illustration of the imaging device from the outward side;

FIG. 5C is a side view of the imaging device;

FIG. 6A is simplified illustration of a first view of a first band part including cavity;

FIG. 6B is simplified illustration of a second view of the first band part including cavity;

FIG. 6C is simplified illustration of a side view of the first band part including cavity;

FIG. 6D is simplified illustration of an inner view of the first band part including cavity;

FIG. 7 is a simplified illustrations of first band part 33 attached to first computational device 31 and including second computational device 32 in cavity 37;

FIG. 8A is a simplified illustration of a user using the wearable imaging device for capturing a first image of a scenery including one or more objects of interest;

FIG. 8B is a simplified illustration of a second image of scenery including one or more objects of interest of FIG. 8A; and

FIG. 9 is a simplified block diagram of object tracking system using the wearable imaging device for a tracking one or more objects of interest in a scenery.

### DESCRIPTION OF THE EMBODIMENTS

The present embodiments comprise a method, one or more devices, and one or more software programs, enabling a user to orient an imaging device at a region of interest, capture an image including the region of interest, and then track the region of interest without looking at a display screen. The method, and/or software programs of the present embodiments, are oriented at user portable imaging devices, including wearable imaging devices, including hand-held, and/or wrist mounted imaging devices.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different figures may use different scales and different scales can be used even within the same drawing, for example different scales for different views of the same object or different scales for the two adjacent objects.

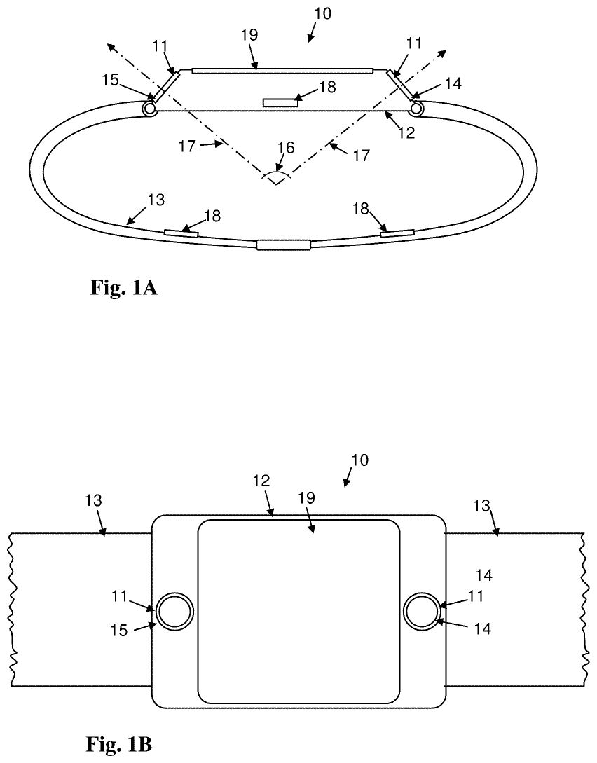

Reference is now made to FIG. 1A, which is a simplified illustration of a side view of a wearable imaging device 10, and to FIG. 1B, which is a simplified illustration of a top view of the wearable imaging device 10, according to one exemplary embodiment.

Wearable imaging device 10 may include one or more imaging units 11, a computational device 12 controllably and/or communicatively coupled to imaging devices 12, and a wearable article 13 coupled to the computational device 12. Wearable article 13 enables a user to wear the computational device 12 with the imaging units 11 on the user's body. In the example shown in FIGS. 1A and 1B, the wearable article 13 is a wrist band for wearing the imaging device 10 on the user's wrist.

The term ‘imaging device’ or an ‘imager’ may refer to any device that is capable of capturing an image of another object or surrounding. Such imaging device may include an optical imaging device such as a camera, an infra-red imaging device, an imaging device using electromagnetic radiation (e.g., radio waves) such as a radio detection and ranging (RADAR) device, an acoustic imager such as an ultrasound imager, a thermal imager, a three-dimensional (3D) imager, etc., and combinations thereof. It is appreciated that imaging units 11 may be of the same type or of different types.

The term ‘image’, or ‘imaging data’ may refer to any type of data including visual data, false-color imaging, aural data, multimedia, three-dimensional (3D) image, etc.

The term ‘computational device’ may refer to any type of computer, or controller, or processing device as will be detailed below. The term ‘wearable article’ may refer to any type of article that can be worn by a user, or attached to a user, or carried by a user, and connect to the computational device 12 and/or imaging units 11.

The term ‘wearable imaging device’ may refer to any imaging device, or a combination of imaging devices, of the same type, and/or of different types, such as the device types listed above, which are carried by a user, and/or attached to a user, and/or worn by a user. Such wearable imaging device may include at least an imaging device, a computational device, a haptic device, and at least one communication device typically including a transmitter and a receiver. The computational device typically includes a processor and memory and/or storage devices. The wearable device may also include a power source such as a battery for operating the computational device, the imaging device, the haptic device, and the communication device.

The memory and/or storage devices of the wearable imaging device may store processor code (software program) and data to be processed by the processor, using the processor code, for operating any of the other devices including but not limited to imaging devices, haptic devices, and communication devices.

The term ‘communication’ or ‘network’ or ‘communication network’ may refer to any type and/or technology of communication and/or networking including, but not limited to wired, cable, wireless, cellular, satellite, and other communication methods and combinations thereof. Such communication methods may include various standards such as PAN and WPAN (e.g., Bluetooth), LAN and WLAN (e.g., Wi-Fi), WAN and WWAN (e.g., cellular), PSTN, PSDN, etc. The term ‘communication device’, etc. may refer to any one or more communication methods, technologies, standards, etc.

The wearable imaging device may be provided in one part or two or more parts. For example, the haptic device may be separated and remote from the main part of the wearable imaging device and communicatively coupled to the main part of the wearable imaging device. For example, the haptic device may be embodied as an earpiece.

The wearable imaging device may include a ‘user interface’ that may communicate ‘user signals’ or user ‘signaling’ between the wearable imaging device and a user of the wearable imaging device. The user interface may include hardware elements and respective software program modules for providing and/or receiving respective user signaling.

Therefore, the user interface may include input for receiving data and/or instructions from the user, and output for providing data and/or instructions to the user. The output and the input may include any type or mode of user interaction including haptic signaling in both directions. The output and the input may include audio (acoustic) signals, visual signals, text, speech, graphics, imaging, tactile signaling, gesture signaling, etc.

Any of the types or modes of user signaling described above (e.g., input audio, output video, etc.) may have a respective hardware element and/or software module. Any of the hardware elements and the software elements may be part of the wearable imaging device or may be incorporated in a separate device.

Regarding visual output, as a non-limiting example, the wearable imaging device may provide the captured image to a screen display. The screen display may be part of the wearable imaging device such as a smartphone. Alternatively, the screen display may be part of another computing device. For example, the wearable imaging device may be worn on a wrist band, and the other computing device may be a smart watch, or a smart phone, etc. In such configuration the wrist mounted imaging device may not include a display and may use the smartphone screen display to display the image to the user. Alternatively, the wrist mounted imaging device may use any screen display to display the image to the user, for example a screen display of a smart-watch, or a smart-eyeglasses.

Similarly, as a non-limiting example, the wearable imaging device may provide audible signals via a build-in speaker, or via a remote earpiece. The wearable imaging device may receive audible signals via a build-in microphone or via a remote microphone embodied within an earpiece device.

The term ‘object of interest’ may refer to any part of an image captured by the wearable imaging device. Particularly, the object of interest may refer to a part of an image captured by the wearable imaging device that the wearable imaging device may identify. Particularly, the object of interest may refer to a part of an image captured by the wearable imaging device that the user has selected and the selection has been provided to the wearable imaging device. The wearable imaging device may identify any number of such objects of interest, and the user may select any number of such objects of interest.

In this document the terms ‘artificial intelligence’ (AI), ‘deep learning’ (DL), ‘machine learning’ (ML), big data, and similar terms may mean the same thing. However, ML may refer to computing predictions, or anticipating how a ‘machine’ would react to a control instruction. The term ‘machine’ here may include the reaction of a user to a haptic signal.

FIG. 1A and FIG. 1B, show two imaging units 11 that may be mounted in substantially opposing directions. For example, a first imaging unit 11 designated by numeral 14 may be directed toward the user (e.g., a selfie camera), and a second imaging unit 11 designated by numeral 15 may be directed away from the user (e.g., a landscape camera). The selfie and landscape imaging units 11 may be mounted in an angle 16 of less than 180 degrees between the optical axes 17 of the lenses of the respective two imaging units 11, as shown in FIG. 1A. It is appreciated that angle 16 may be typically between 90 degrees and 180 degrees.

Any of the selfie and landscape imaging units 11 may be a wide-angle imaging device. Alternatively, or additionally, any of the selfie and landscape imaging units 11 may include a plurality of relatively narrow-angle imaging units 11 that together form a wide-angle view.

Alternatively, or additionally, any of the selfie and landscape imaging units 11 may include a combination of wide-angle and narrow-angle imaging units 11. Alternatively, or additionally, any of the selfie and landscape imaging units 11 may be of a different type, or include a third imaging unit 11 of a different type. For example, the selfie imaging unit 11 may be a 3D imager, or an RF imager, or an ultrasound imager. For example, imaging units 15 may include two parallel cameras of different view angle (e.g., narrow and wide) and a 3D sensor. For example, imaging unit 15 may include two cameras directed at different angles and a thermal sensor.

Wearable imaging device 10 (or computational device 12) may include haptic user-interface device 18. For example, the haptic user-interface device 18 may be a vibrating device, and/or an acoustic device, or any other device that can generate a signal to the user of the wearable imaging device 10 that the user can perceive (haptic signaling) without looking at the wearable imaging device 10, or any display associated with, or communicatively coupled to, imaging device 10.

As shown in FIGS. 1A, wearable imaging device 10 (or computational device 12) may include a plurality of haptic user-interface device 18, or a similar arrangement providing haptic signaling, that may enable a user to perceive (without looking at the wearable imaging device 10) a plurality of different signals such as ‘up’, ‘down’, ‘left’ ‘right’, etc.

Wearable imaging device 10 (or computational device 12) may also include a display 19 and/or any other type of user-interface device.

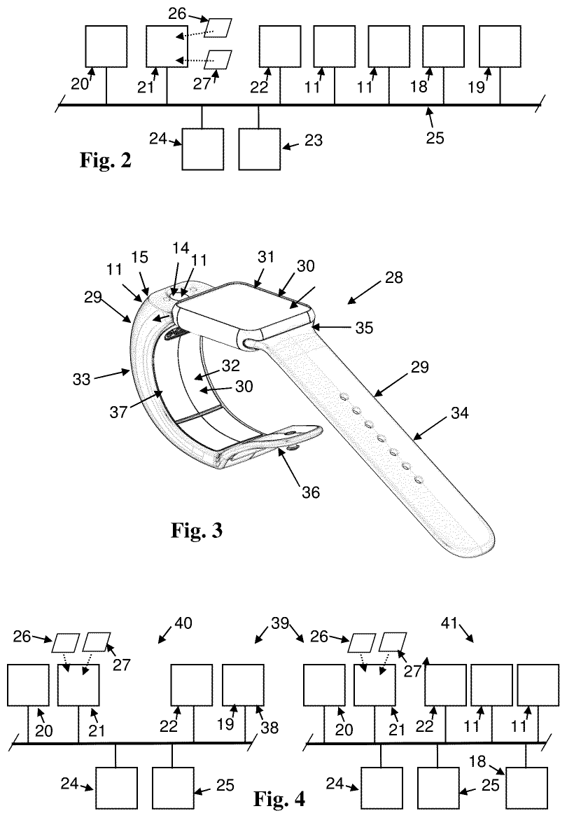

Reference is now made to FIG. 2, which is a simplified block diagram of computational device 12 with the imaging devices 11, according to one exemplary embodiment.

As an option, the wearable imaging device 28 of FIG. 2 may be viewed in the context of the previous Figures. Of course, however, FIG. 2 may be viewed in the context of any desired environment. Further, the aforementioned definitions may equally apply to the description below.

As shown in FIG. 2, computational device 12 may include a processor or controller 20, a memory and/or storage device 21, a communication device 22 such as a transceiver (or a receiver and transmitter devices), the one or more imaging units 11, one or more haptic user-interface device 18, a power supply 23 and power source 24 such as a battery, all connected via a bus 25. Computational device 12 may also include display 19, and/or any other type of user-interface device.

As shown in FIG. 2, memory and/or storage device 21 may include one or more software programs 26 and/or data 27, which may be executed and/or processed by processor 20 to control imaging units 11, and or communication device 22, and/or data 27. Data 27 may include imaging content captured by any of the imaging units 11. Such imaging content may include any type of imaging such as a still frame or a video stream.

It is appreciated that communication device 22 may provide any one or more of the communication methods, technologies and/or standards disclosed above. Particularly communication device 22 may provide PAN networking such as Bluetooth, WLAN networking such as Wi-Fi, and/or cellular networking, and any combination of such networking.

Reference is now made to FIG. 3, which is a simplified illustration of a wearable complex 28 including a wearable article 29 and two computational devices 30, at least one of which is an imaging device, according to one exemplary embodiment.

As an option, the wearable imaging device 28 of FIG. 3 may be viewed in the context of the previous Figures. Of course, however, the wearable imaging device 28 of FIG. 3 may be viewed in the context of any desired environment. Further, the aforementioned definitions may equally apply to the description below.

As shown in FIG. 3, wearable complex 28 may be designed to be worn on a user's limb, such as a user's extremity, such as a user's wrist. Thus, wearable complex 28 may include wearable article 29 in the form of a strip or a wristband arranged to attach the wearable complex 28 to a user's wrist, and one or more computational devices 30.

For example, wearable complex 28 may include a first computational device 30 such as a computerized watch, or a smartwatch, designated by numeral 31, and a second computational device 30 such as an imaging device designated by numeral 32. As shown in FIG. 3, imaging device 32 may include one or more imaging units 11.

For example, two imaging units 11 of imaging device 32 may be mounted in substantially opposing directions so that a first imaging unit 11 (designated by numeral 14) may be directed towards the user (e.g., a selfie camera), and a second imaging unit 11 (designated by numeral 15) may be directed away from the user (e.g., a landscape camera). The selfie 14 and landscape 15 imaging units 11 may be mounted in an angle of less than 180 degrees between the optical axes of the lenses of the respective two imaging units 11, similar to the imaging units 11 shown in FIG. 1A. It is appreciated that angle 16 may be typically between 90 degrees and 180 degrees.

It is appreciated that wearable complex 28 may function like wearable imaging device 10 with the difference that wearable complex 28 may have more than one processor and its associated components, and that the two computational devices of wearable complex 28 may communicate via respective communication units.

As shown in FIG. 3, wearable complex 28 may include wearable article 29 including one or more band parts such as a first band part 33 and a second band part 34. Both the first band part 33 and the second band part 34 may include a connector 35 to connect the respective band part to the computerized watch 31 on either side of the computerized watch 31. First band part 33 and the second band part 34 may also include a respective buckle part 36 to connect the first band part 33 to the second band part 34. The first band part 33, or second band part 34 (or both) may also include the imaging device 32.

As shown in FIG. 3, wearable complex 28, via wearable article 29, may include a cavity 37, for example, within first band part 33. Cavity 37 may be arranged with its opening towards the user's wrist. The imaging device 32 may be inserted into cavity 37, via the cavity opening, before the wearable complex 28 is warn on the user's wrist so that the imaging device 32 may be secured between the cavity 37 and the user's wrist.

Imaging device 32 may include a plurality of imaging units 11. Typically, at least one imaging unit 11 is mounted as a selfie camera towards the user, and at least one imaging unit 11 is mounted as a landscape camera directed away from the user. FIG. 3 shows the selfie imaging unit 11 while the landscape imaging unit 11 is hidden behind wearable article 29.

As shown in FIG. 3, wearable complex 28 may include a display 38, typically as a part of computerized watch 31.

Reference is now made to FIG. 4, which is a simplified block diagram 39 of wearable complex 28 including a block diagram 40 of computational device 31 (e.g. a smartwatch), a block diagram 41 of imaging device 32, according to one exemplary embodiment.

As an option, each of the block diagrams of FIG. 4 may be viewed in the context of the previous Figures. Of course, however, each of the block diagrams of FIG. 4 may be viewed in the context of any desired environment. Further, the aforementioned definitions may equally apply to the description below.

As shown in FIG. 4, block diagram 40 of computational device (computerized watch) 31 may include a processor 20, a memory and/or storage unit 21 including software program 26 and or data and/or content 27, a communication device 22, a display 38 or any other user interface 19, a power supply 24 and a power source 25.

As shown in FIG. 4, block diagram 41 of computational device (imaging device) 32 may include a processor 20, a memory and/or storage unit 21 including software program 26 and or data and/or content 27, a communication device 22, two or more imaging units 11, one or more haptic user-interface device 18, a power supply 24 and a power source 25.

It is appreciated that the two communication devices 22 of computerized watch 31 and imaging device 32 may provide WPAN such as Bluetooth networking between the processors of computerized watch 31 and imaging device 32. It is appreciated that the communication device 22 of computerized watch 31 may also provide WLAN (e.g., Wi-Fi) or WWAN (e.g., cellular) communication with network server(s) and with remote client device(s).

Considering any possible combination, and/or complex, of a wearable or handheld computational device and imaging device, such as, for example, the computational device 12 with the imaging units 11 of FIG. 1A and FIG. 1B, the computational devices 30 and imaging units 11 of FIG. 3, etc., the user of the screen display may look at the image displayed on the screen display (19 or 38) and select one or more objects of interest. For example, the user may tap on the screen display on the part of the image that forms an object of interest.

The screen display (e.g. 19), or the processor operating the screen display, for example, when the screen display (e.g. 19) is a part of another computing device, may then communicate an identification of the selected object to the processor of the wearable imaging device.

The identification of the selected object (e.g., to the processor of the wearable imaging device) can be performed, for example, by communicating an identification of the displayed frame, and coordinates of the screen location tapped by the user. The wearable imaging device may then determine the object of interest, which may be any visual object. Typically, the object of interest may be an image of a particular human, or an image of a head of a particular human, etc. It is appreciated that the wearable imaging device may determine any number of objects of interest according to the user's selections.

As another non-limiting example, the wearable imaging device, or the processor of the wearable imaging device, may identify one or more objects withing the image captured, and communicate such objects to the user, via any user interface mode. For example, the user wearable imaging device may provide audible identification of the identified objects such as: “a man”, “Robert”, “Anna”, “a dog”, “a blue car”, “Eucalyptus tree”, etc. The user may then select any particular object of interest, for example, by dictating the identification phrase provided by the wearable imaging device.

As another non-limiting example, the user of the wearable imaging device may dictate a name, term, or any other description of any particular object within the scenery (e.g., “a woman”, “Robert”, “Anna”, “a dog”, “a blue car”, “Eucalyptus tree”, etc.). The processor of the wearable imaging device may then execute speech recognition to determine the type of object as dictated by the user. Thereafter, the processor of the wearable imaging device may scan the captured image to detect the required object of interest.

It is appreciated that the wearable imaging device may use any one or more of such user interactions to determine one or more objects of interest. The user may later add more objects of interest to, or remove any object of interest from, the list of tracked objects of interest.

As another non-limiting example, the user of the wearable imaging device may repeatedly interact to better specify the object of interest. The user may say “track car”, and the wearable imaging device may respond with “blue car, red car, moving car”. The user may then specify “red car”. Such iterative interaction may continue to achieve optimal identification of the object of interest. Such iterative interaction may take any form or type of user interface as well as any combination of user interfaces, such as visual, and audible, as well as touch selection, typing, and speech recognition.

As another non-limiting example, the wearable imaging device may once or repeatedly request the user to confirm that the tracked object is the object of interest. This may happen for example, when the appearance of the object changes. For example, the object may move or turn or the user may move or turn and therefore the object may be seen from a different angle or perspective.

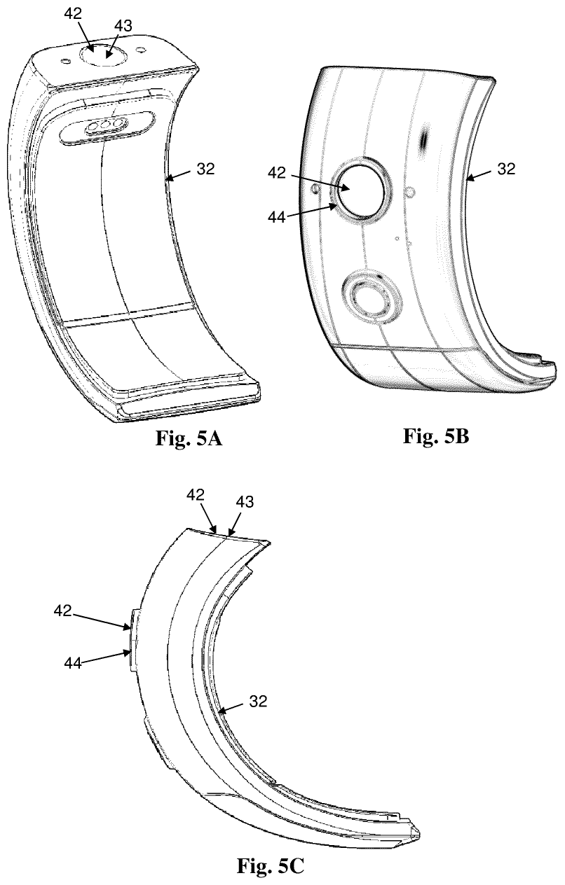

Reference is now made to FIG. 5A, which is a simplified illustration of imaging device 32 from the inward side (facing the wrist), and to FIG. 5B, which is a simplified illustration of imaging device 32 from the outward side (away from the wrist), and to FIG. 5C, which is a side view of imaging device 32, according to one exemplary embodiment. Imaging device 32 of FIGS. 5A, 5B, and 5C is analogous to imaging device 32 of FIG. 3.

As an option, the illustrations of FIGS. 5A and 5B may be viewed in the context of the previous Figures. Of course, however, the illustrations of FIGS. 5A and 5B may be viewed in the context of any desired environment. Further, the aforementioned definitions may equally apply to the description below.

Imaging device 32 may include one or more imaging sensors 42 such as a camera. For example, imaging device 32 may include a first imaging sensor (camera) 42 designated by numeral 43 and oriented in a first direction, such as outwards, substantially away from the user, and a second imaging sensor (camera) 42 designated by numeral 44 and oriented in a second direction (e.g., inwards, substantially towards the user). Imaging device 32 may be inserted into cavity 37 of wearable complex 28 and/or first band part 33.

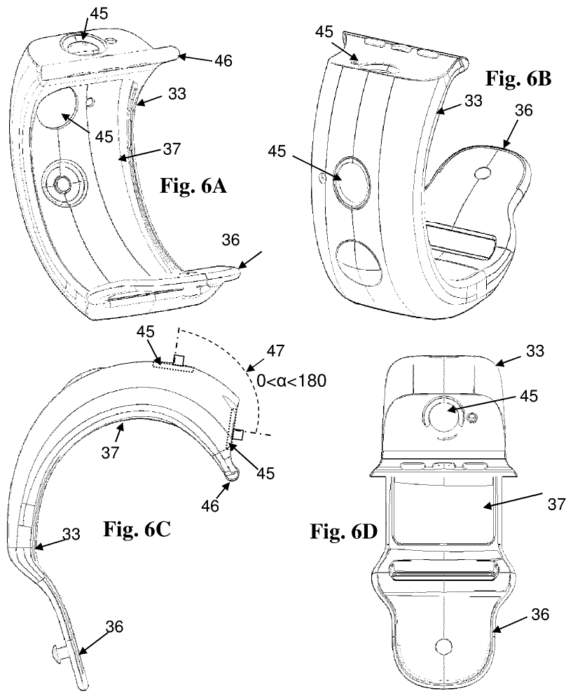

Reference is now made to FIG. 6A, FIG. 6B, FIG. 6C, and FIG. 6D, which are simplified illustrations of a first band part 33 including cavity 37, according to one exemplary embodiment. It is appreciated that first band part 33 of FIG. 6A, FIG. 6B, FIG. 6C, and FIG. 6D may be equivalent to first band part 33 of FIG. 3.

As an option, the illustrations of FIG. 6A, FIG. 6B, FIG. 6C, and FIG. 6D, may be viewed in the context of the previous Figures. Of course, however, the illustrations of FIG. 6A, FIG. 6B, FIG. 6C, and FIG. 6D, may be viewed in the context of any desired environment. Further, the aforementioned definitions may equally apply to the description below.

It is appreciated that cavity 37 is illustrated as a part of first band part 33 as an example, and that cavity 37 may be part of second band part 34.

It is appreciated that cavity 37 has the shape of imaging device 32 and/or imaging device 32 has the shape of cavity 37.

As shown in FIGS. 6A, 6B, 6C, and 6D, first band part 33 may include one or more openings 45, such as a hole, to expose a respective imaging sensor (camera) 42 of imaging device 32, and particularly, to expose a lens of imaging sensors 42. Consequently, imaging device 32 may include at least one sensor (camera) having a lens arranged to fit against the respective openings 45 (hole) in cavity 37.

The first band part 33 may also include a connector element 46 to connect to computational device 30, such as the first computational device 31, such as a smart watch. The connector 46 may be included at an end of the first band part 33.

The first band part 33 may also include a connector, such as a buckle part 36, to connect to the second band part 34. The buckle part 36 may be included at an end of the first band part 33, such as the end opposite to connector 46.

The second band part 34, similarly to the first band part 33, may include a third end part including a connector to connect to computational device 30, such as the a first computational device 31, such as a smart watch., and a fourth end part including a connector to connect to the buckle part 36 of the first band part 33. Therefore, the wearable complex 28, including the first band part 33, the computational device 30, and the second band part 34, may be wrapped around a user's wrist.

As shown in FIG. 6C, cavity 37 may include two openings 45 (hole) for the two imaging sensors 42 (e.g., cameras) with an angle 47 between the openings 45. As shown in FIG. 6C, angle 47 may be measured between the respective axes that are each perpendicular to the area of the respective opening 45 at the center of the opening 45. Alternatively, angle 47 may be measured between the respective plains of openings 45. As shown in FIG. 6C, angle 47 may have a value that is larger than zero and smaller than 180 degrees. Particularly, angle 47 may have a value between 30 and 120 degrees.

It is appreciated that the angle between the optical axes of the lenses of the respective two imaging sensors 42 is equal to angle 47. The optical axis of imaging sensor 42 being measured as the perpendicular to the area of the lens at the center of the lens.

As shown in FIG. 3, at least one of the imaging sensors 42 may be mounted with an angle between the imaging sensor 42 and the plain of the screen display of the computerized watch (smartwatch) 31. The angle being measured, for example, between the optical axis of the imaging device and the perpendicular to the surface of the screen display. This angle may be larger than zero and smaller than 90 degrees.

Altogether, the wearable article 29, and particularly the first band part 33 on which the two imaging sensors 42 are mounted, may have the shape where the two openings 45, and therefore the lenses of the two imaging sensors 42, are arranged with an angle between the cameras and the plain of the screen display of the computerized watch (smartwatch) 31 that is larger than zero and smaller than 90 degrees, and an angle 47 between the two imaging sensors 42 that is larger than zero and smaller than 180 degrees.

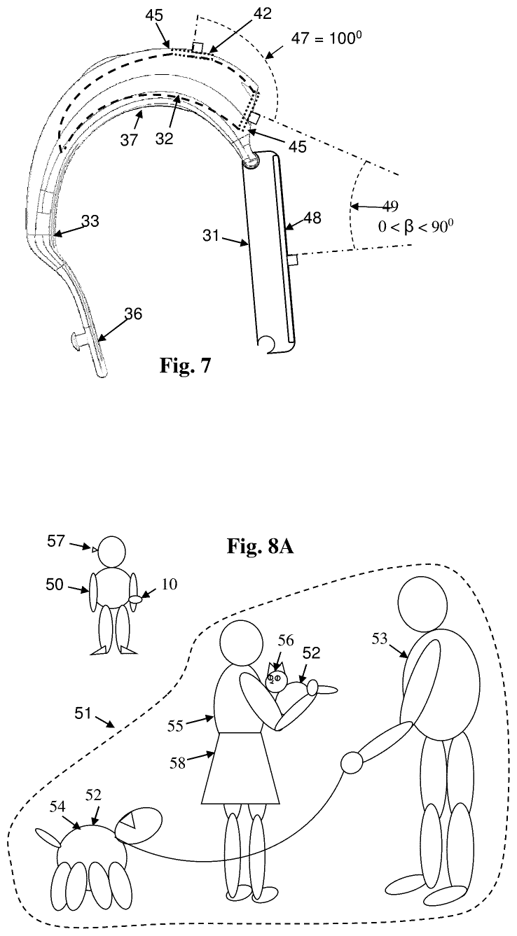

Reference is now made to FIG. 7, which is simplified illustrations of first band part 33 attached to first computational device 31 and including second computational device 32 in cavity 37, according to one exemplary embodiment.

As an option, the illustration of FIG. 7, may be viewed in the context of the previous Figures. Of course, however, the illustrations of FIG. 7, may be viewed in the context of any desired environment. Further, the aforementioned definitions may equally apply to the description below.

Computational device 31 may be a computerized watch, or a smartwatch, which may include a display 48. The second computational device 32 may be an imaging device and may include two imaging sensors 42. The first band part 33 may include cavity 37, which may include two openings 45 adapted for the two imaging sensors 42. As an example, the two openings 45 of FIG. 7 are arranged with an angle of 90 degrees between the planes of the openings 45. As an example, the two imaging sensors 42 of second computational device 32 may be arranged with an angle (47) of 100 degrees between the planes of the lenses of imaging sensors 42 (or between the optical axes if imaging sensors 42). Hence, an opening 45 may be adapted to allow the plane of the lens to be in an angle to the plane of the opening.

As shown in FIG. 7, at least one of the openings 45 and/or imaging sensors 42 may be in an angle 49 to the plane of display 48. Angle 49, between the optical axis of imaging sensors 42 and the perpendicular to the plane of display 48, may have a value that is greater zero and less than 90 degrees.

For example, one of the imaging sensors 42 may have an angle between zero and 90 degrees between its optical axis and the perpendicular to the to the plane of display 48, and the other imaging sensors 42 may have an angle between 90 and 180 degrees between its optical axis and the perpendicular to the to the plane of display 48.

It is appreciated that while FIG. 3. FIGS. 5A and 5B, FIGS. 6A to 6D, and FIG. 7 describe two cameras, any number of cameras are possible (as well as a single camera) and any other type of imaging device, or combination of types of imaging devices may be used.

It is appreciated that wearable imaging device 10 may refer to any of the imaging devices and computational devices of FIGS. 1A, 1B, 2, 3, 4, 5A, 5B, 5C, 6A, 6B, 6C, 6D, and 7 and their combinations. In this respect wearable imaging device 10 and/or the software program thereof may create a three-dimensional (3D) model of each of the tracked object of interest. The 3D model may then be used to track and identify the object of interest from various angles as the object of interest may move around, turn, rotate, bend, etc. Or when the user may move around changing the view angle, and/or perspective, of the tracked object of interest.

Identification of an object of interest may be based on the particular distances, or ratio, between two or more identifying features. For example, the ratio between height and width. The distances between the eyes, nose, and mouth. The shape of the ears and their position and size ratio to the head, etc. The identification features may include colors such as the color of the hair and/or eyes. Color of particular clothing elements and/or decoration elements, etc. Physical elements, decorations and similar features and visual elements of an inanimate object such as a car, etc.

The wearable imaging device 10 (or any of the associated computational devices) may therefore have a library of general 3d models. Such library may be stored internally, or remotely in a remote server that may be accessed by a plurality of wearable imaging device 10 (or any of the associated computational devices).

Such identification features may be embedded, or fitted, within a 3D model. Such 3D model may be stored within the wearable imaging device 10 (or any of the associated computational devices), and/or a remote server.

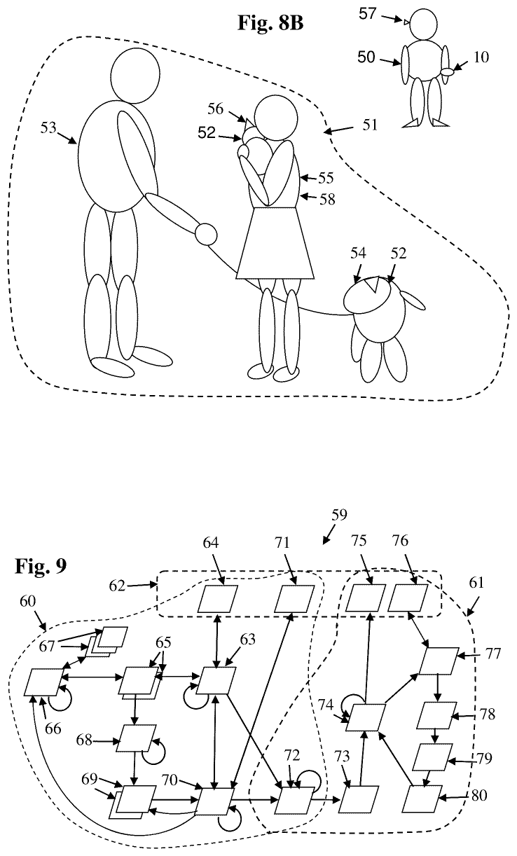

Reference is now made to FIG. 8A, which is a simplified illustration of a user 50 using the wearable imaging device 10 (and optionally an associated computational device) for capturing a first image of a scenery 51 including one or more objects of interest 52, according to one exemplary embodiment.

As an option, each of the illustration of FIG. 8A may be viewed in the context of the previous Figures. Of course, however, each of the illustrations of FIG. 8A may be viewed in the context of any desired environment. Further, the aforementioned definitions may equally apply to the description below.

As a non-limiting example, the scenery 51 may include several objects, such as a man 53 with a dog 54 on a leash and a woman 55 with a cat 56 on her hands. The objects of interest 52 may be, for example, the cat 56, or the dog 54, or both.

As shown in FIG. 8A user 50 and/or wearable imaging device 10 may track the object(s) of interest 52 without user 50 having to look at a display, or an eyepiece, or a similar device presenting the captured image. As seen in the example of FIG. 8, the user 50 may be looking at the scenery 51 as a whole. Alternatively, user 50 may concentrate on an object that is not an object of interest, such as the man 53, while wearable imaging device 10 may track the object(s) of interest 52. Alternatively, user 50 may be looking away from the scenery, and still the wearable imaging device 10 may track the object(s) of interest 52.

It is appreciated that wearable imaging device 10 may guide user 50 how to move or rotate wearable imaging device 10 so that wearable imaging device 10 may track the object(s) of interest 52. It is appreciated that wherever the term ‘wearable imaging device 10’ it may refer to, or include, any associated computational device.

In this respect, wearable imaging device 10, or any associated computational device, may send to user 50 haptic signals (audible, visible, tactile, etc.) that may guide user 50 to move wearable imaging device 10 so that wearable imaging device 10 may track the object(s) of interest 52.

For example, wearable imaging device 10 (or an associated computational device) may send to user 50 haptic signals in the form of audible signals via an earpiece 57, which may be communicatively coupled to wearable imaging device 10 (possibly via an associated computational device) via Bluetooth, or a similar communication protocol.

Reference is now made to FIG. 8B, which is a simplified illustration of a second image of scenery 51, according to one exemplary embodiment.

As an option, each of the illustration of FIG. 8B may be viewed in the context of the previous Figures. Of course, however, each of the illustrations of FIG. 8B may be viewed in the context of any desired environment. Further, the aforementioned definitions may equally apply to the description below.

As nay be seen in 8B, at least some of the object(s) of interest 52 have changed their position and/or orientation with respect to user 50 and particularly with respect to wearable imaging device 10. Considering the tracking of the object(s) of interest 52, wearable imaging device 10 may now capture a different image of the object(s) of interest 52. Such situation may also result from the user moving about scenery 51.

To enable continuous tracking of the object(s) of interest 52, wearable imaging device 10 may continuously scan each of the object(s) of interest 52, and continuously create a three-dimensional (3D) model of each of the object(s) of interest 52. Wearable imaging device 10 may then compare the captured image of the objects of scenery 51 with a respective rendering of the 3D model of the object of interest 52 to identify the particular object of interest 52, to determine their exact location, or their respective absence, and to guide user 50 to maneuver wearable imaging device 10 accordingly.

Wearable imaging device 10 may use artificial intelligence (AI) or a similar tool that may provide an estimation of the validity of the identification (recognition) of each of the tracked object(s) of interest 52. In this regard the AI (or a similar software tool) may compare the captured image of the objects of scenery 51 with several rendered images of 3D models of several objects of interest 52 to determine percentage validity recognition. Each such 3D model may present the respective object of interest 52 from a different orientation.

For example, if the best estimation of recognition falls below a predetermined threshold the wearable imaging device 10 may request user 50 to confirm the recognition or to point wearable imaging device 10 at the appropriate image of the respective object of interest 52, or to start again the tracking process by capturing a new ‘comprehensive’ shot of scenery 51, and identifying the object(s) of interest 52.

Wearable imaging device 10 may also determine one or more associated object of interest 58. For example, the woman 55 is holding the cat on her hands and therefore may be determined as an associated object of interest 58 of the cat 56. It may be easier for wearable imaging device 10 to track an associated object of interest 58 and then identify the respective object of interest 52 in close vicinity. Such approach may be useful, for example, until there is a sufficiently detailed 3D model of the object of interest 52.

Reference is now made to FIG. 9, which is a simplified block diagram of object tracking system 59 using the wearable imaging device 10 (and optionally one or more associated computational devices) for a tracking one or more objects of interest in a scenery, according to one exemplary embodiment.

As an option, each of the block diagram of FIG. 9 may be viewed in the context of the previous Figures. Of course, however, each of the block diagram of FIG. 9 may be viewed in the context of any desired environment. Further, the aforementioned definitions may equally apply to the description below.

It is appreciated that object tracking system 59 may track one or more objects of a scenery, such as objects of interest 52 in scenery 51 of FIGS. 8A and 8B. It is appreciated that tracking system 59 may be embodies in a wearable imaging device 10, and optionally also using one or more associated computational devices as shown and described above, for example as wearable complex 28. It is appreciated that the term ‘associated computational device’ may also refer to a network server.

It is appreciated that object tracking system 59 may track simultaneously a plurality of objects of interest in the scenery as captured by the wearable imaging device 10. It is appreciated that object tracking system 59 may independently track each of the tracked objects of interest. In this regard, the description below may be understood to describe the tracking of a single object of interest whether tracked alone or as part of tracking a plurality of objects of interest.

Tracking system 59 may be embodied as a software program executed by one or more processors, such as a processor of wearable imaging device 10, and/or an associated computational device as shown and described with reference to FIG. 2 and FIG. 4. It is appreciated that tracking system 59 may be stored in, or embodied on, a non-transitory computer readable medium, and may include instructions that, when executed by at least one processor, cause the processor to perform the functions of the modules described below.

Tracking system 59 may include two main processes, an image tracking process 60 and a Haptic feedback process 61. Both processes may be executed in parallel, by the same processor, or by different processors.

Tracking system 59 may also include a user interface (UI) module 62 that may access any type of user interface device. For example, audible UI, such as a speaker, or an earpiece, tactile UI, such as a tactile vibrator, visual UI, such as a touch sensitive display, etc. Any such UI, or combination of UI facilities, may be used for interaction with a user operating the wearable imaging device 10 and tracking system 59.

It is appreciated that UI module 62 may enable tracking system 59 to interact with the user without using any display device. For example, by using verbal (vocal) prompts, verbal (vocal) inputs, and audible and/or tactile orientation instructions.

Image tracking process 60 may capture and produce an image of the scenery, as a frame, or a sequence of frames. Image tracking process 60 may then identify the object(s) of interest in the scenery, or in each of the frames. Image tracking process 60 may then track the motion of each of the object(s) of interest within the sequence of frames.

Haptic feedback process 61 may instruct the user how to manipulate the wearable imaging device 10, based on the anticipated motions of the object(s) of interest, so as to maintain the object(s) of interest within the following captured frames.

When tracking a plurality of objects of interest, image tracking process 60 may be embodies either (option A) as a single task tracking all the objects of interest, or (option B) as a plurality of independent task, each tracking one of the objects of interest, where the plurality of independent tasks may be executed in parallel (by a single processors, or by a plurality of processors).

As a non-limiting example, image tracking process 60 may start with image capture subroutine 63 by capturing an image if a scenery such as scenery 51 of FIG. 8A. Image tracking process 60 may then provide the captured image to a user such as user 50 of FIG. 8A, for example using a display associated with wearable imaging device 10. Image tracking process 60 may then receive from the user, via object selection subroutine 64, a selection of one or more objects of interest.

Image capture subroutine 63 may then add the image of the selected objects of interest to a database 65 of objects' images. This action of capturing images of the object(s) of interest is repeated, for example to scan the object(s) of interest as they move or turn, or as the wearable imaging device 10 moves about the object(s) of interest. The repetition is shown in FIG. 9 as a curled arrow returning back to the same subroutine.

The repeated operation of image capture subroutine 63 may take the form of capturing a video stream, or the stream of still frames. The video stream, or the stream of still frames, can be displayed to the user, thus enabling the user to add objects of interest, or the remove objects of interest, or to interact with the image tracking process 60. However, the purpose of object tracking system 59 is to enable a user of the wearable imaging device 10 to track objects of interest without looking at any display.

When the number of scanned images of an object of interest reaches a predefined threshold value, 3D modeling subroutine 66 may use the object images of database 65 to create a three-dimensional (3D) model 67 for each particular object of interest. Thereafter, using the respective 3D model 67, 3D modeling subroutine 66 may add synthesized images of a respective object of interest to database 65 of object images.

3D modeling subroutine 66 may therefore operate repetitively in two modes, a modelling mode and a rendering mode. In the modelling mode the 3D modeling subroutine 66 may operate repetitively to generate new and improved 3D models 67 of any particular object of interest. In the rendering mode, 3D modeling subroutine 66 may operate repetitively to render synthesized images of each object of interest.

For example, 3D modeling subroutine 66 may generate a new 3D model 67 of a particular object of interest when new ‘natural’ (‘real’) images of the particular object of interest are captured by the image capture subroutine 63. For example, the new ‘natural’ images may reveal a new aspect, or a new angle of view, of the particular object of interest, or more details.

For example, 3D modeling subroutine 66 may generate (render) new synthesized images of a particular objects of interest for more intermediate angles of view of the objects of interest as may be required. If the new ‘natural’ images have revealed a new detail of the object of interest 3D modeling subroutine 66 may render new synthesized images with the new detail. Similarly, 3D modeling subroutine 66 may render new synthesized images providing more accurate details.

It is appreciated that 3D modeling subroutine 66 may replace an ‘old’ 3D model 67 of a particular object of interest with a ‘new’ 3D model 67 of the same object of interest. It is appreciated that 3D modeling subroutine 66 may replace an ‘old’ synthesized image of a particular object of interest with a ‘new’ synthesized image.

It is appreciated that when tracking a plurality of objects of interest, 3D modeling subroutine 66 may independently manage a respective plurality of 3D model 67, as well as a respective plurality of collections of real (‘natural’) and synthesized images of each of the objects of interest (via database 65).

When database 65 of object images includes a sufficient number of images to train an AI model, AI image training subroutine 68 may be executed to create an AI image recognition model 69. The training data may include both images captured by image capture subroutine 63 (real images, natural images) and synthesized images rendered by 3D modeling subroutine 66. The AI image recognition model 69 may then be used to recognize the various objects of interest in the following imaging frames.

AI image training subroutine 68 may operate repeatedly, to generate new AI image recognition models 69 when a sufficient number of new images are added to database 65 of object images, or when a sufficient number of images of database 65 are replaced with new and/or more detailed images. A new AI image recognition model 69 may then replace a previously generated AI image recognition model 69.

AI image recognition model 69 may then be used by object recognition subroutine 70 to recognize objects of interest in the current frame captured by image capture subroutine 63. AI image recognition model 69 may recognize each of the recognized objects with a respective recognition precision, typically provided as a percentage value.

If the recognition precision falls below a predefined validation threshold value (but typically above a minimum threshold value), object recognition subroutine 70 may communicate with UI object confirmation subroutine 71. Object confirmation subroutine 71 is a user interface (UI) subroutine that may request the user to confirm the recognition of the particular object or reject it. Object recognition subroutine 70 may then receive from object confirmation subroutine 71 a confirmation that the recognized object is indeed the correct object, or a rejection of the recognition result.

Object recognition subroutine 70 may then communicate the confirmation, or the rejection, to AI image recognition model 69, to 3D modeling subroutine 66, and to image capture subroutine 63.

For example, a feedback to the image capture subroutine 63 may enable the image capture subroutine 63 to add the image of the recognized object (if confirmed) to database 65 of object images. For example, a feedback to the AI image recognition model 69 may increase (if confirmed) or decrease (if rejected) the recognition precision value (e.g., reinforced machine learning). For example, a feedback to the 3D modeling subroutine 66 may initiate the rendering of one or more new synthesized images, for example showing the object from angles lacking from database 65.

Object confirmation subroutine 71 may also label various objects of interest of database 65. For example, the user may provide a verbal confirmation in the form of a label such as “father”, “flower”, “Anna”, “dog”, “Eucalyptus tree”, etc. object recognition subroutine 70 may then recognize an object by its name, or label.

Such labels may be used by the object selection subroutine 64 to present the object to the user (e.g., to prompt the user to select the object as an object of interest, or not to select). Object confirmation subroutine 71 may record the label confirmation and the recorded vocal labels may be used by object confirmation subroutine 71 to request the confirmation. For example, by playing to the user a prompt such as “is this Anna?”, or “is this Eucalyptus tree?”. The user may then provide a verbal confirmation (i.e., positive reinforcement) or rejection (i.e., negative reinforcement), such as “yes” or “no”.

Object labels such as provided by the user via object confirmation subroutine 71 may be used by object selection subroutine 64 to indicate the object of interest. For example, the user may verbally (vocally) pronounce “Robert”, or “a dog”, or “a cat” to indicate the object of interest to track.

Alternatively, the user may initiate the object tracking system 59, which may capture an image of the scenery (e.g., scenery 51 of FIG. 8A), scan the scenery and indicate to the user, via object selection subroutine 64, which objects are found. For example, vocally indicating “Robert”, “a woman”, “a dog”, and “a cat”. Object selection subroutine 64 may then receive from the user vocal instructions (selections) such as “a dog”, and “a cat”.

It is appreciated that Object selection subroutine 64 and object confirmation subroutine 71 enable UI module 62 to interact with the user using vocal (audible) prompts and user selections/confirmations.

Such labels may also be used by the AI image training subroutine 68 to train an image recognition model 69 in supervised mode.

As shown in FIG. 9, there may be several different databases 65 of objects (natural and synthesized images) and several AI image recognition models 69. For example, there may be a current image recognition model 69 being used for the currently captured scenery. Optionally or additionally, there may also be a general image recognition model 69 being used to suggest objects of the user's selection as disclosed above. Optionally or additionally, there may also be one or more special purpose image recognition model 69 being used in special occasions such as family gatherings, work meetings, etc. A database 65, namely a sub-database 65, or a particular collection of objects pertaining to a particular scenery may be created, or determined, ad-hoc, for the generation of a ‘lightweight’ image recognition model 69.

Such general, and/or special purpose AI image recognition model 69 may use labeled objects, and have a name (label) for each AI image recognition model 69. Hence, a user may select (via object selection subroutine 64) a particular special purpose AI image recognition model 69 instead of selecting the various objects of this model one by one. Obviously, the selection of a particular special purpose AI image recognition model 69 may be instructed by the user in a vocal manner.

Object tracking subroutine 72 may then scan, and analyze, a number of the recent frames received from the image capture subroutine 63 to determine the direction of motion (in the current frame) of each tracked object(s) of interest.

It is appreciated that eventually subroutines 63, 66 (in both modes), 68, 70 and 72 may be processed repeatedly and in parallel, and substantially asynchronously.

Haptic feedback process 61 may start with object tracking subroutine 72 to determine where (e.g., direction) and how (e.g., speed) each object of interest is moving within the current frame of imaging. For example, object tracking subroutine 72 may measure the direction of motion of the object within the frame. Object tracking subroutine 72 may also measure the speed of motion of the object within the frame. Object tracking subroutine 72 may also measure the distance of the object from an edge of the frame. Object tracking subroutine 72 may also measure the relative direction and speed between two or more objects of interest. In this regard, object tracking subroutine 72 may combine the motions of the individual objects of interest into a group motion of all the objects of interest within the frame.

This individual object motion data and/or group object motion data may then be communicated to camera orientation analysis subroutine 73 that may determine how to manipulate the wearable imaging device 10 so that the next frames will capture all the objects of interest.

The required frame motion data created by the camera orientation analysis subroutine 73 may then be communicated to haptic signaling subroutine 74.

Haptic signaling subroutine 74 may then communicate haptic signals to the user, via haptic UI module 75. The haptic signals may use any sensory signal and combinations thereof. For example, the haptic signal may be audible, for example provided to the user via earpiece 57.

For example, such audible signal may employ beat frequency oscillator (BFO) where the frequency indicates the diversion of the wearable imaging device 10 from the optimal orientation. E.g., a higher audio frequency may indicate a larger diversion of the wearable imaging device 10 from the optimal orientation. In this regard, the frequency (pitch) may indicate a latitude angle from a pole position being the optimal orientation. This may enable the use of a single frequency to guide the user to the optimal orientation of the wearable imaging device 10.

Alternatively, haptic signaling subroutine 74 may use two or four different frequencies to indicate two or four respective directions (horizontal and vertical, or up, down, left, and right) and use repetition rate to indicate the deviation from the optimal orientation.

Alternatively, haptic signaling subroutine 74 may use a combination of tactile vibration and audible signal (one, two or four different frequencies) to indicate respective directions (horizontal and vertical, or up, down, left, and right) and the deviation from the optimal orientation.

Haptic signaling subroutine 74 may therefore communicate to the user via the UI module 62, as an audible and/or tactile signal any combination of signal representing a measure of the direction of motion of the object within the frame, a measure of the speed of motion of the object within the frame; and/or a measure of the distance of the object from the edge of the frame.

As the user moves the wearable imaging device 10 the motion of wearable imaging device 10 is measured by motion sensor 76. Motion sensor 76 may sample the movement of wearable imaging device 10 at a high rate to track the exact body motion of the user in response to each particular haptic signal. The motion data produced by the motion sensor 76 may then be communicated to a haptic response analysis subroutine 77.

It is appreciated that motion sensor 76 may include an accelerometer, and/or a gyroscope, and/or inertial measurement unit (IMU) and/or any similar motion sensing devices. Alternatively, the motion sensor 76 may analyze the images captured by image capture subroutine 63 to determine the motion of the wearable imaging device 10 similar to an IMU. An IMU may be preferred for lower battery power consumption while image analysis may be preferred for increased measurement accuracy.

Haptic response analysis subroutine 77 may compare motion data received from Motion sensor 76 with haptic signaling received from haptic signaling subroutine 74, may generate respective haptic response records, and may store the haptic response records in haptic database 78.

Data included in haptic database 78 may depict, for example, start time, stop time, acceleration rate, stability (or drifting), and similar values associated with the motion of wearable imaging device 10 responsive to respective haptic signals.

Start time may measure the time it takes for the user to start moving the wearable imaging device 10 after the respective haptic signal starts. Stop time may measure the time it takes for the user to stop moving the wearable imaging device 10 after the respective haptic signal stops. Different start and stop times may be measured for different haptic signals, as well as for different sequences of haptic signals.

The same applies to motion linearity, or non-linearity, such as rates of acceleration and deceleration. Different stability (or drifting) value may be measured for different respective body postures (positions).

It is appreciated that motion accuracy, latency (start and stop time), linearity (acceleration, deceleration), stability, etc. may vary spatially and/or temporally. The term ‘spatially’ here may refer to the body position, or limb position, of the user. The term ‘temporally’ here may refer to the time lapsing from the beginning of the current signaling, and/or from the time lapsing from the beginning of the current tracking. Therefore, each record of haptic response may be labeled with a plurality of labels depicting various ranges of accuracy, latency, linearity, spatially and/or temporally.

Haptic response records of haptic database 78 may then be used by haptic training subroutine 79 to train a haptic AI model 80 of the user. Haptic AI model 80 may anticipate, or predict, the user's response to each haptic signal so that the haptic signaling subroutine 74 may select the best haptic signal to generate the required motion of wearable imaging device 10.

It is appreciated that the selected haptic signal my represent optimized direction of motion of the wearable imaging device, start time, stop time, acceleration, deceleration, stability, etc. It is appreciated that the haptic AI model 80 may be better termed haptic ML model 80 or haptic DL model 80.

It is appreciated that any subroutine of object tracking system 59 may reside on a network server, and/or be executed by a network server. As a non-limiting example, such network server may be regarded as an associated computational devices. For example, such network server may communicate with the wearable imaging device 10, directly and/or indirectly, over WLAN (e.g., Wi-Fi), and/or WWAN (e.g., cellular).

For example, the following subroutines may be executed on a network server: 3D modeling subroutine 66 in any of its modelling and rendering modes, or both modes, AI image training subroutine 68, and haptic training subroutine 79. Therefore the remote network server may also store any of database 65, 3D model 67, AI image recognition models 69, haptic database 78, and haptic AI models 80, and/or copies thereof.

The term ‘concentration’, or ‘image selection’, or ‘zoom’, or ‘zoom function’, or ‘zoom operation’, may refer to selecting any part of an image taken by an imaging unit. For simplicity, the term ‘zoom’ may be used, referring to any of the above terms. For example, the term ‘zoom’ may refer to any type of imaging effect that determines a partial field of view within the overall field of view of the imaging device.

The term ‘zoom’ here may refer to ‘electronic zoom’, where the zoom function is provided by processing the image captured by the imaging device to select the zoom image. For example, the term ‘zoom’ may refer to selecting a particular narrow-angle view from a wide-angle image captured, for example, by a landscape imaging unit 11.

The term ‘zoom’ may also refer to selecting any part of an image (i.e., zoom part) concentrated around, or withing a ‘region of interest’ of the user operating the imaging device (locally or remotely). Additionally, the term ‘zoom’ may include selecting an aspect ratio of the selected part of the image, or zoom part, which may be different from the aspect ratio (ratio between the vertical measure and the horizontal measure) of the image as originally captured by the imaging device.

The term ‘zoom’ may also refer to selecting or identifying a ‘region of interest’ or an ‘object of interest’. In this respect, the ‘region of interest’ or an ‘object of interest’ is marked within the original image captured by the imaging device. For example, the ‘region of interest’ or the ‘object of interest’ is marked for post-processing.

Post processing may be executed by the capturing and/or transmitting device, and/or by the receiving device, and/or by one or more intermediating servers in the network. For example, in cases such as post-processing by a computational device other than the capturing and/or transmitting device, the capturing and/or transmitting device communicates the original image as captured with the marking of the ‘region of interest’ and/or the ‘object of interest’.

For this matter, with the availability of a plurality of cameras positioned in different directions, zoom may be effected by selecting a camera that is better pointed at the selected direction, or object.

Typically, the selected part, or zoom part, of the image, may be communicated to any number of remote entities, such as a remote terminal, or a node (server) in an intermediate location in a communication network. The image may be any type of image such as a still image and/or a video stream.

It is appreciated that the zoom operation may affect the location of the selected part within the entire (original) image as captured by the landscape imaging unit 11, and/or the relative size of the selected part as part of the entire (original) image as captured by the landscape imaging unit 11

It is appreciated that any object (such as the head of the user serving as an example) captured by the selfie imaging unit 11 may serve to provide a measure forming the basis for controlling the zoom function. For example, the size of the object with respect to the entire image as captured by the selfie imaging unit 11. For example, the change of size of the object with respect to the entire image as captured by the selfie imaging unit 11. For example, the position of the object withing the frame of the entire image as captured by the selfie imaging unit 11. For example, the orientation of the object with respect to the entire image as captured by the selfie imaging unit 11 (e.g., the direction in which the user is looking).

It is appreciated that any logic may be applied to correlate between the images captured by the selfie imaging unit 11 to affect the zoom operation. Such logic may be a correlation between one or more images captured by selfie imaging unit 11, affecting a correlated, or an opposite (inverse) correlated zoom between one or more images captured by landscape imaging unit 11.

It is appreciated that any motion in the image captured by the selfie imaging unit 11 to affect the zoom operation the landscape imaging unit 11. For example, moving the wearable imaging device 10 (or wearable complex 28) closer to the user, or away from the user, or up, or down, or to the left, or to the right, with respect to the user, or any type of rotation of wearable imaging device 10 (e.g., six degrees of freedom).

Additionally or alternatively, the wearable imaging device 10 (or wearable complex 28) may operate a plurality of vibrating elements distributed on the wrist band may also indicate how to move the wearable imaging device 10 (or wearable complex 28) to capture a region of interest (or an object of interest) in the direction in which the user is looking.

It is therefore appreciated that the imaging device such as the wearable imaging device 10, and/or a method implemented by the imaging device, and/or a software program executed by the wearable imaging device 10, may enable a user capturing an image, to focus, and/or zoom, the image, on an object, simply by looking at the object.

As described above, the imaging device may include a plurality of image-sensing devices comprising at least a first image-sensing device and a second image-sensing device mounted to capture a second image in substantially opposing direction to a first image captured by the first image-sensing device, and a controller communicatively coupled to the at least first image-sensing device and second image-sensing device.

The controller may capture the first image content from the first image-sensing device, and the second image content from the second image-sensing device, substantially simultaneously. The controller may then analyze the first image content to detect a user of the imaging device, to determine a direction in which the user is looking, forming a user looking direction. The controller may then capture the second image from the second image-sensing device, and zoom the second image in the user looking direction by selecting a part of the second image concentrated in the user looking direction.

Alternatively, or additionally, the controller may zoom the second image by selecting a second image-sensing device from the plurality of image sensing devices, where the selected second image-sensing device is directed in the user looking direction, and wherein the at least two image-sensing devices comprise at least three image-sensing mounted in respective at least three different directions.

The imaging device may be packaged in a packaging unit including the controller and the plurality image-sensing devices and a band coupled to the packaging unit attaches the packaging unit to a wrist of a user of the imaging device.

The zoom operation may be performed as an electronic zoom, and at least one image-sensing device of the plurality of image-sensing devices may be a wide-angle image-sensing device. Alternatively, or additionally, the second image-sensing device may be a wide-angle image-sensing device, and further alternatively or additionally, the first image-sensing device may be a wide-angle image-sensing device. The controller may control the first image-sensing device as a selfie camera directed at the user of the imaging device.

The imaging device may further include a transmitter for communicating in a communication network, and the controller may use the transmitter to communicate the zoom part of the second image to at least one of a terminal of the communication network, and an intermediating communication node in the communication network.

The zoom operation may include selecting a part of the second image content, by keeping a ratio between a measure of the selected part and the second image content. The ratio may decrease over time, for example at a predetermined rate, for example as long as the user looking direction is substantially maintained. The ratio between the measure of the zoom part and the original second image may reduce over time until a predetermined value is reached. Such predetermined value may represent an optical parameter such as granularity, and/or resolution.

The controller may also analyze the first image content to detect a user, such as the user of the imaging device, and to determine a direction in which the user is looking, for example, by determining the direction of the position of the user's head, and/or the direction of the position of the user's eyes. Such analysis may form a user looking direction.

The controller may also determine the field of view of the second image-sensing device. The controller may then provide a signal to the user if the direction in which the user is looking is not within the field of view of the landscape (second) image-sensing device, such as imaging unit 11.

The signal provided by the controller to the user may include a haptic signal that can be perceived by the user of the imaging device. The haptic signal may include one or more vibration signals, and/or one or more auditory signals. Such auditory signal may include a verbal instruction.

The haptic signal may include any number of different signals that may indicate to the user a direction and/or mode of moving the imaging device to align the landscape (second) image-sensing device, such as imaging unit 11 with the user's looking direction. Such plurality of signals may indicate, for example, up, down, right, left, etc. Such as six degrees of motion.

The controller may cease the signal to the user when the controller determines that the direction in which the user is looking is within the field of view of the landscape (second) image-sensing device.

The controller may change the signal to the user according to a difference between the direction in which the user is looking and the field of view of the second image-sensing device. For example, such change may affect an amplitude, and/or frequency, and or cadence, of the vibration, or auditory signal.

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent, or patent application was specifically and individually indicated to be incorporated herein by reference. In addition, citation, or identification of any reference in this application shall not be construed as an admission that such reference is available as prior art.

What is claimed is:

1. A method for instructing a user of a wearable imaging device to point the wearable imaging device in a direction of a selected object, the method comprising:
capturing a plurality of frames, each comprising an image of a scenery comprising the object;
detecting a motion of the object within the scenery; and
providing a haptic signal to the user, the haptic signal informing the user how to move the wearable imaging device to keep the object within the captured scenery.

2. The method according to claim 1, additionally comprising at least one of:
detecting a motion of the object comprising detecting at least one of
the direction of motion of the object within the frame;
the speed of motion of the object within the frame; and
the distance of the object from an edge of the frame; and
providing a haptic signal to the user, the haptic signal comprising at least one of:
a measure of the direction of motion of the object within the frame;
a measure of the speed of motion of the object within the frame; and
a measure of the distance of the object from the edge of the frame.

3. The method according to claim 1, additionally comprising at least one of:
detecting the object within the scenery the detecting comprising:
collecting a plurality of images of the object from different angles;
producing a 3D model of the object based on the collected plurality of images of the object;
using the 3D model, rendering a plurality of images of the object from intermediate angles to create a training collection of images;
using the training collection of images, training an imaging AI-model for recognizing the object; and
using the imaging AI-model to detect the object in the captured scenery.

4. The method according to claim 3, additionally comprising at least one of:
receiving from the imaging AI-model a measure of validity of the detection of the object in the scenery;
instructing at least one of:
instructing the rendering of at least one image of the object from intermediate angles to add to the training collection of images; and
instructing the training of a new imaging AI-model for recognizing the object.

5. The method according to claim 1, additionally comprising:
detecting a motion of the wearable imaging device responsive to the haptic signal provided to the user;
creating a training collection of responses comprising a plurality of motions of the wearable imaging device responsive to a respective haptic signals provided to the user;
using the training collection of responses, training a signaling AI-model;
using the signaling AI-model, producing the haptic signal provided to the user.

6. A non-transitory computer readable medium including instructions that, when executed by at least one processor of a mobile communication device, cause the at least one processor to perform operations for instructing a user of a wearable imaging device to point the wearable imaging device in a direction of a selected object, the actions comprising:
capturing a plurality of frames, each comprising an image of a scenery comprising the object;
detecting a motion of the object within the scenery; and
providing a haptic signal to the user, the haptic signal informing the user how to move the wearable imaging device to keep the object within the captured scenery.

7. The actions according to claim 6, additionally comprising at least one of:
detecting a motion of the object comprising detecting at least one of
the direction of motion of the object within the frame;
the speed of motion of the object within the frame; and
the distance of the object from an edge of the frame; and
providing a haptic signal to the user, the haptic signal comprising at least one of:
a measure of the direction of motion of the object within the frame;
a measure of the speed of motion of the object within the frame; and
a measure of the distance of the object from the edge of the frame.

8. The actions according to claim 6, additionally comprising at least one of:
detecting the object within the scenery the detecting comprising:
collecting a plurality of images of the object from different angles;
producing a 3D model of the object based on the collected plurality of images of the object;
using the 3D model, rendering a plurality of images of the object from intermediate angles to create a training collection of images;
using the training collection of images, training an imaging AI-model for recognizing the object; and
using the imaging AI-model to detect the object in the captured scenery.

9. The actions according to claim 8, additionally comprising at least one of:
receiving from the imaging AI-model a measure of validity of the detection of the object in the scenery;
instructing at least one of:
instructing the rendering of at least one image of the object from intermediate angles to add to the training collection of images; and
instructing the training of a new imaging AI-model for recognizing the object.

10. The actions according to claim 6, additionally comprising:
detecting a motion of the wearable imaging device responsive to the haptic signal provided to the user;
creating a training collection of responses comprising a plurality of motions of the wearable imaging device responsive to a respective haptic signals provided to the user;
using the training collection of responses, training a signaling AI-model;
using the signaling AI-model, producing the haptic signal provided to the user.

11. A wearable imaging device comprising:
an imaging device operative to capture a plurality of frames, each comprising an image of a scenery comprising the object;
a processing device communicatively coupled to the imaging device and operative to execute a first software module for detecting a motion of the object within the scenery; and
the processing device additionally communicatively coupled to at least one user interface device and additionally operative to execute a second software module for providing a haptic signal to the user via the at least one user interface device, the haptic signal informing the user how to move the wearable imaging device to keep the object within the captured scenery.

12. The wearable imaging device according to claim 11, additionally comprising at least one of:
the first software module being additionally operative to detect a motion of the object comprising detecting at least one of
the direction of motion of the object within the frame;
the speed of motion of the object within the frame; and
the distance of the object from an edge of the frame; and
the second software module being additionally operative to provide a haptic signal to the user, the haptic signal comprising at least one of:
a measure of the direction of motion of the object within the frame;
a measure of the speed of motion of the object within the frame; and
a measure of the distance of the object from the edge of the frame.

13. The wearable imaging device according to claim 11, additionally comprising at least one of:
the first software module being additionally operative to detect the object within the scenery the detecting comprising:
collecting a plurality of images of the object from different angles;
producing a 3D model of the object based on the collected plurality of images of the object;
using the 3D model, rendering a plurality of images of the object from intermediate angles to create a training collection of images;
using the training collection of images, training an imaging AI-model for recognizing the object; and
using the imaging AI-model to detect the object in the captured scenery.

14. The wearable imaging device according to claim 13, additionally comprising at least one of:
receiving from the imaging AI-model a measure of validity of the detection of the object in the scenery;
instructing at least one of:
instructing the rendering of at least one image of the object from intermediate angles to add to the training collection of images; and
instructing the training of a new imaging AI-model for recognizing the object.

15. The wearable imaging device according to claim 11, additionally comprising:
the second software module being additionally operative to:
detect a motion of the wearable imaging device responsive to the haptic signal provided to the user;
create a training collection of responses comprising a plurality of motions of the wearable imaging device responsive to a respective haptic signals provided to the user;
use the training collection of responses, training a signaling AI-model;
use the signaling AI-model, producing the haptic signal provided to the user.
